(19) United States
(12) Patent Application Publication
(10) Pub. No.: US 2017/0305454 A1
(43) Pub. Date: Oct. 26, 2017

(54) TELESCOPIC SHAFT

(71) Applicants: SEOHAN INDUSTRY CO., LTD., Jincheon-gun (KR); KOREA FLANGE CO., LTD., Ulsan (KR)

(72) Inventor: JEONG LYUL PARK, Hwaseong-si (KR)

(73) Assignees: SEOHAN INDUSTRY CO., LTD., Jincheon-gun (KR); KOREA FLANGE CO., LTD., Ulsan (KR)

(21) Appl. No.: 15/481,449

(22) Filed: Apr. 6, 2017

(30) Foreign Application Priority Data
Apr. 25, 2016 (KR) 10-2016-0050458

(51) Int. Cl. B62D 1/185; F16D 3/22; F16D 3/18; F16D 3/221; B62D 1/18

(52) U.S. Cl. CPC B62D 1/185; F16D 3/221; B62D 1/18; F16D 3/18; F16D 3/22

(57) ABSTRACT

A telescopic shaft is provided. The telescopic shaft includes a first shaft including a first coupler having an inner circumferential surface including an external straight groove and an external inclination groove formed thereon, the external straight groove having a semi-circular cross section and being formed in parallel to a rotation axis and the external inclination groove having a semi-circular cross section, being inclined with respect to the external straight groove at a predetermined angle, and being shaped like a spiral, a second shaft including a second coupler inserted into the first coupler and having an outer circumferential surface including an internal straight groove and an internal inclination groove formed thereon, the internal straight groove having a semi-circular cross section and corresponding to the external straight groove and the internal inclination groove having a semi-circular cross section, being inclined in an opposite direction to the external inclination groove at a predetermined angle with respect to the internal straight groove, and being shaped like a spiral, and a plurality of balls arranged in a line in an axial direction between the external straight groove and the internal straight groove, one ball being arranged between the external inclination groove and the internal inclination groove, wherein the first shaft and the second shaft are coupled to extend and retract in an axial direction, thereby preventing play from occurring in a circumferential direction and preventing separation of balls.

### CROSS-REFERENCE TO RELATED APPLICATIONS

This application claims priority from Korean Patent Application No. 10-2016-0050458 filed on Apr. 25, 2016, in the Korean Intellectual Property Office, the disclosure of which is incorporated herein by reference in its entirety.

### BACKGROUND OF THE INVENTION

### Field of the Invention

Apparatuses and methods consistent with the present invention relate to a telescopic shaft, and more particularly, to a telescopic shaft for minimizing play.

### Description of the Related Art

In general, a steering wheel used a vehicle is connected to a steering gear box via a steering shaft. In this case, the steering shaft rotates a gear in the steering gear box to rotate a direction of a vehicle wheel by as much as a rotation amount of the steering wheel by a driver.

In general, a length of the steering shaft is basically determined according to vehicle type but, recently, a telescopic steering shaft that is adjustable in angle and length in consideration of a body type of a driver has been widely used.

In addition, a vehicle drive shaft applies an outboard fixed joint and shaft and an inboard perturbing joint. In this regard, there is a problem in that vehicle layout is limited due to an angle limit of the inboard joint and a vehicle vibrates due to influence of axial force generated in the inboard joint during a period with a high angle and driving force. In addition, even if the same joint is used in vehicles, shafts have different lengths due to different layouts between vehicles and, thus, these problems impede product inclusion and sharing due to different types of drive shafts.

Korean Patent No. 10-0793692 (registered and published on Jan. 11, 2008) discloses a telescopic drive shaft for overcoming such problems of a conventional drive shaft.

The aforementioned telescopic steering shaft or telescopic drive shaft is changeable in length and, simultaneously, transfers rotation power by a plurality of balls disposed in a line in grooves formed in an axial direction. However, some play occurs due to the characteristics of this structure and, thus, a problem arises in that there is a need for a separate structure or device for preventing separation of balls.

### CITED REFERENCE

### Patent Document

(Patent Document 1) Korean Patent No. 10-0793692 (published on Jan. 11, 2008).

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a telescopic shaft for minimizing play and preventing separation of balls.

According to an aspect of the present invention, a telescopic shaft includes a first shaft including a first coupler having an inner circumferential surface including an external straight groove and an external inclination groove formed thereon, the external straight groove being formed in parallel to a rotation axis and the external inclination groove being inclined with respect to the external straight groove at a predetermined angle and being shaped like a spiral, a second shaft including a second coupler inserted into the first coupler and having an outer circumferential surface including an internal straight groove and an internal inclination groove formed thereon, the internal straight groove corresponding to the external straight groove and the internal inclination groove being inclined in an opposite direction to the external inclination groove at a predetermined angle with respect to the internal straight groove and being shaped like a spiral, and a plurality of balls arranged in a line in an axial direction between the external straight groove and the internal straight groove, one ball being arranged between the external inclination groove and the internal inclination groove, wherein the first shaft and the second shaft are coupled to extend and retract in an axial direction.

An even number of the external inclination grooves may be used, and any one of the external inclination grooves and another external inclination groove adjacent thereto may be inclined in opposite directions, and an even number of the internal inclination grooves corresponding to the external inclination grooves may be used, and any one of the internal inclination grooves and another internal inclination groove adjacent thereto may be inclined in opposite directions.

The external straight groove and the external inclination groove of the first coupler may be alternately arranged in a circumferential direction on the inner circumferential surface, and the internal straight groove and the internal inclination groove of the second coupler may be alternately arranged in a circumferential direction on the outer circumferential surface.

The telescopic shaft may further include a cage disposed between the inner circumferential surface of the first coupler and the outer circumferential surface of the second coupler, including a first space portion incised in an axial direction and a second space portion incised in a circumferential direction, and shaped like a tube, and the plurality of balls is disposed in a line between the external straight groove and the internal straight groove may be positioned in the first space portion and one ball is disposed between the external inclination groove and the internal inclination groove is positioned in the second space portion.

A length of the first space portion in an axial direction may be significantly greater than a length of the second space portion in the axial direction, and a width of the second space portion in a circumferential direction may be greater than a width of the first space portion in the circumferential direction.

The external inclination groove and the internal inclination groove may be disposed to cross each other, and as the first shaft and the second shaft extend and retract in an axial direction, an intersection between the external inclination groove and the internal inclination groove may be moved in a circumferential direction.

One ball disposed between the external inclination groove and the internal inclination groove may be positioned at the intersection between the external inclination groove and the internal inclination groove, and play between the first shaft and the second shaft in a circumferential direction may be prevented from occurring.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a perspective view of a telescopic shaft according to an exemplary embodiment of the present invention;

FIG. 2 is a partially exploded perspective view of a telescopic shaft according to an exemplary embodiment of the present invention;

FIG. 3 is a sectional view of a telescopic shaft taken along line A-A′ of FIG. 1;

FIG. 4 is a reference diagram illustrating a view obtained by spreading components of a telescopic shaft according to an exemplary embodiment of the present invention; and

FIGS. 5A and 5B are a reference diagram for explanation of an operation of a telescopic shaft according to an exemplary embodiment of the present invention.

### DETAILED DESCRIPTION OF THE EXEMPLARY EMBODIMENTS

Certain exemplary embodiments of the present invention will now be described in greater detail with reference to the accompanying drawings. As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

In the following description, the same reference numerals are used for the same elements even in different drawings.

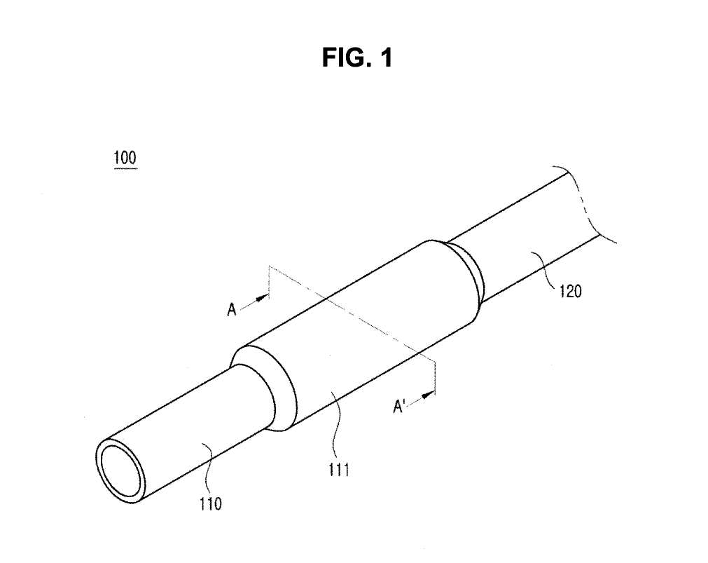

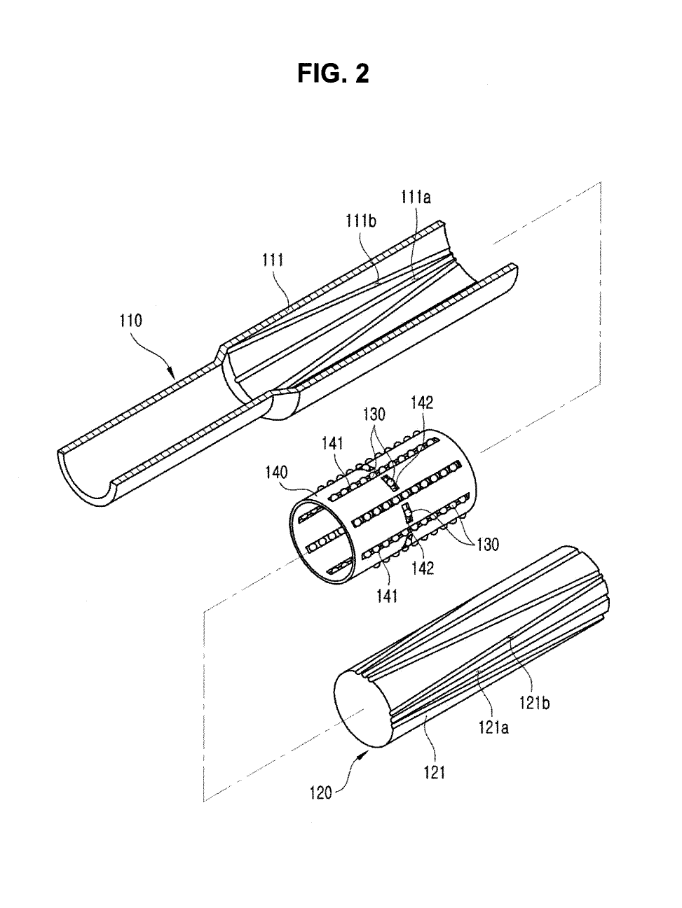

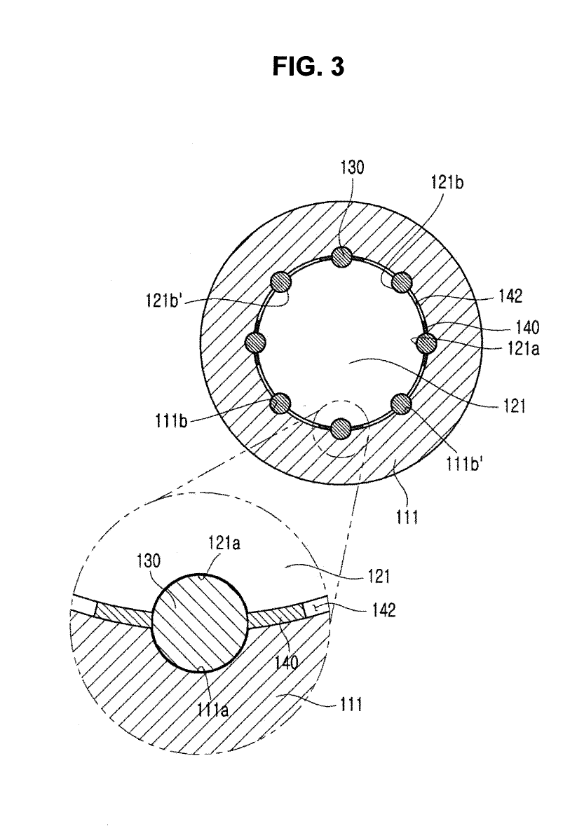

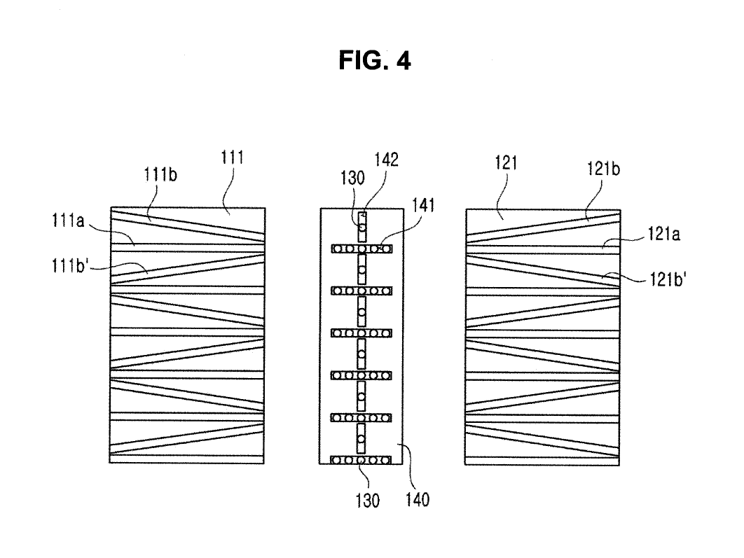

FIG. 1 is a perspective view of a telescopic shaft 100 according to an exemplary embodiment of the present invention. FIG. 2 is a partially exploded perspective view of the telescopic shaft 100 according to an exemplary embodiment of the present invention. FIG. 3 is a sectional view of the telescopic shaft 100 taken along line A-A′ of FIG. 1. FIG. 4 is a reference diagram illustrating a view obtained by spreading components of the telescopic shaft 100 according to an exemplary embodiment of the present invention.

For convenience of description, directions used herein will be defined. An axial direction refers to a longitudinal direction of a first shaft 110 and a second shaft 120 and a radial direction refers to a direction toward an outer circumferential surface from a rotation center of the first shaft 110 in FIG. 1.

In addition, a circumferential direction refers to a rotation direction along an outer circumferential surface of a first shaft.

Referring to FIGS. 1 to 4, the telescopic shaft 100 according to an exemplary embodiment of the present invention may include the first shaft 110 including a first coupler 111, the second shaft 120 including a second coupler 121 inserted into the first coupler 111, a plurality of balls 130 interposed between an inner circumferential surface of the first coupler 111 and an outer circumferential surface of the second coupler 121, and a cage 140 positioned between the inner circumferential surface of the first coupler 111 and the outer circumferential surface of the second coupler 121 to prevent separation of the plurality of balls 130.

The first shaft 110 may include the first coupler 111 shaped like a cylinder into which the second coupler 121 to be described below is inserted.

In this case, an external straight groove 111a and an external inclination groove 111b may be formed on the inner circumferential surface of the first coupler 111 and the external straight groove 111a may be formed in parallel to a rotation axis and may have a semi-circular cross section and the external inclination groove 111b may be inclined with respect to the external straight groove 111a at a predetermined angle, may be shaped like a spiral, and may have a semi-circular cross section.

Here, a plurality of external straight grooves 111a and a plurality of external inclination grooves 111b may be used.

An even number of external inclination grooves 111b may be used and any one of the external inclination grooves 111b and another external inclination groove 111b adjacent thereto may be inclined in opposite directions.

The external straight groove 111a and the external inclination groove 111b may be alternately arranged in the circumferential direction on the inner circumferential surface of the first coupler 111.

That is, the external straight groove 111a, the external inclination groove 111b inclined at a predetermined angle, the external straight groove 111a, and the external inclination groove 111b inclined in an opposite direction at a predetermined angle may be arranged in the order stated in the circumferential direction.

In this case, intervals between the external straight grooves 111a may be constant and the external straight grooves 111a may be radially arranged.

The second shaft 120 may include the second coupler 121 inserted into the first coupler 111 and shaped like a cylinder.

In this case, the second coupler 121 may include an internal straight groove 121a that is formed on the outer circumferential surface to correspond to the external straight groove 111a in parallel to the rotation axis and has a semi-circular cross section, and an internal inclination groove 121b that is formed to be inclined with respect to the internal straight groove 121a at a predetermined angle, is shaped like a spiral, and has a semi-circular cross section.

Here, a direction in which the internal inclination groove 121b is inclined may be opposite to that of the external inclination groove 111b.

In addition, a plurality of internal straight grooves 121a and a plurality of internal inclination grooves 121b may be used and an even number of internal straight grooves 121a and an even number of internal inclination grooves 121b may be used.

In this case, like the external inclination groove 111b, with regard to the internal inclination grooves 121b, any one of the internal inclination grooves 121b and another internal inclination groove 121b adjacent thereto may be inclined in opposite directions.

The internal straight groove 121a and the internal inclination groove 121b may be alternately arranged in the circumferential direction on the outer circumferential surface of the second coupler 121.

That is, the internal straight groove 121a, the internal inclination groove 121b inclined at a predetermined angle, the internal straight groove 121a, and the internal inclination groove 121b inclined in an opposite direction at a predetermined angle may be arranged in the order stated in the circumferential direction.

The external inclination groove 111b and the internal inclination groove 121b may be arranged to face the external inclination groove 111b and the internal inclination groove 121b that are inclined in opposite directions to the former grooves.

Meanwhile, intervals between the internal straight grooves 121a may be constant and the internal straight grooves 121a may be radially arranged.

The plurality of balls 130 may be arranged in a line between the external straight groove 111a and the internal straight groove 121a.

In this case, a plurality of balls arranged between the external straight groove 111a and the internal straight groove 121a may transfer rotation power of the first shaft 110 to the second shaft 120 and, simultaneously, may allow the second coupler 121 to smoothly slide in an axial direction in the first coupler 111 and, thus, the telescopic shaft 100 according to an exemplary embodiment of the present invention may easily extend and retract in the axial direction.

One ball may be disposed between the external inclination groove 111b and the internal inclination groove 121b inclined in an opposite direction thereto.

In this case, one ball disposed between the external inclination groove 111b and the internal inclination groove 121b may be moved in a circumferential direction as the second coupler 121 slides in the first coupler 111.

The cage 140 may be shaped like a tube and disposed between the inner circumferential surface of the first coupler 111 and the outer circumferential surface of the second coupler 121.

The cage 140 may include a first space portion 141 that is incised in an axial direction and a second space portion 142 that is incised in a circumferential direction.

Here, the plurality of balls 130 arranged in a line between the external straight groove 111a and the internal straight groove 121a may be positioned in the first space portion 141 and one ball 130 arranged between the external inclination groove 111b and the internal inclination groove 121b may be positioned in the second space portion 142.

In this case, one ball disposed between the external inclination groove 111b and the internal inclination groove 121b may not be moved in an axial direction and may be move only in a circumferential direction and, thus, the cage 140 may not moved in the axial direction and may be maintained in its location and play may be minimized.

The location of the cage 140 may be maintained and, thus, separation of the plurality of balls 130 arranged in a line between the external straight groove 111a and the internal straight groove 121a may be prevented.

Hereinafter, an operation of the telescopic shaft 100 according to an exemplary embodiment of the present invention will be described in detail.

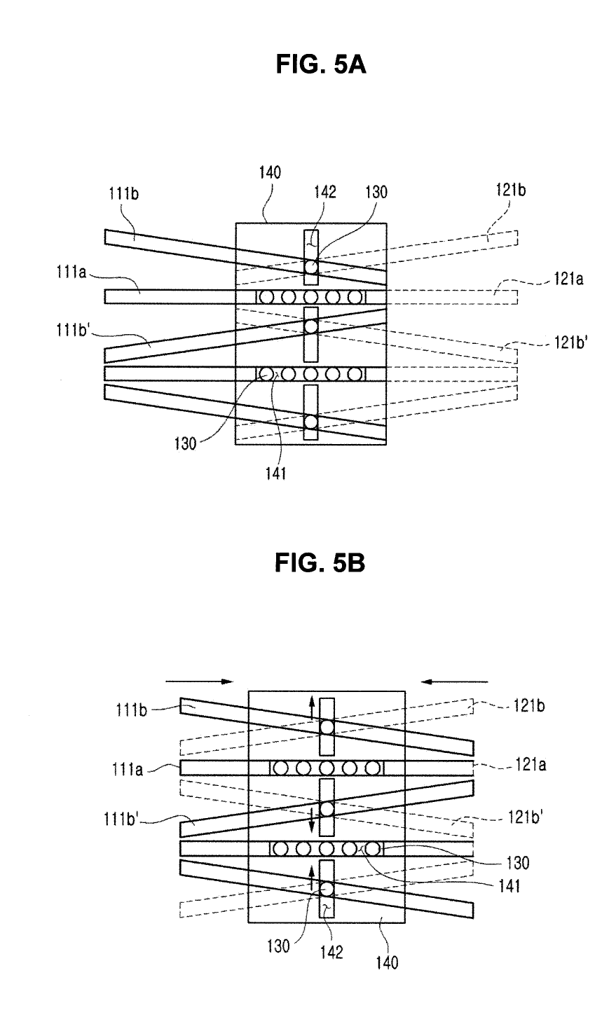

FIGS. 5A and 5B are a reference diagram for explanation of an operation of the telescopic shaft 100 according to an exemplary embodiment of the present invention.

Referring to FIG. 5A, the external straight groove 111a, the internal straight groove 121a, and the first space portion 141 may be positioned on the same line and the balls 130 may be arranged in the first space portion 141.

The external inclination groove 111b and the internal inclination groove 121b may be inclined in opposite directions to cross each other and one ball 130 may be disposed at an intersection between the external inclination groove 111b and the internal inclination groove 121b.

In this case, the second space portion 142 may be incised in the circumferential direction such that one ball 130 disposed at the intersection between the external inclination groove 111b and the internal inclination groove 121b moves in the circumferential direction.

As seen from FIG. 5B, when the second coupler 121 is deeply inserted into the first coupler 111, the intersection between the external inclination groove 111b and the internal inclination groove 121b may not be moved in the axial direction and may be moved in the circumferential direction.

Accordingly, one ball 130 disposed between the external inclination groove 111b and the internal inclination groove 121b may move only in the circumferential direction along the second space portion 142 and may not move in the axial direction.

Accordingly, the cage 140 may not be moved in the axial direction and may be maintained in its location.

As such, the cage 140 may be moved in the axial direction so as to prevent separation of a plurality of balls that are arranged in a line in the first space portion 141.

The plurality of balls that are arranged in a line in the first space portion 141 may transfer rotation power of the first shaft 110 to the second shaft 120 or may oppositely transfer rotation power of the second shaft 120 to the first shaft 110.

In other words, the plurality of balls arranged in a line in the first space portion 141 functions as a key inserted between the first shaft 110 and the second shaft 120.

In this case, when the external straight groove 111a, the internal straight groove 121a, and a plurality of balls that are arranged in a line between the external straight groove 111a and the internal straight groove 121a transfer rotation power, play may occur in a circumferential direction due to a slight difference between dimensions.

However, the telescopic shaft 100 according to an exemplary embodiment of the present invention may be configured in such a way that one ball positioned between the external inclination groove 111b and the internal inclination groove 121b is inserted into the intersection between the external inclination groove 111b and the internal inclination groove 121b so as to prevent play from occurring in the circumferential direction.

As described above, the telescopic shaft 100 according to an exemplary embodiment of the present invention may prevent play in the circumferential direction using one ball positioned between the external inclination groove 111b and the internal inclination groove 121b and may fix the location of the cage 140 so as to prevent separation of the ball 130.

A telescopic shaft according to the present invention may be configured in such a way that a ball rolling along an external inclination groove and an internal inclination groove that cross each other is positioned at an intersection between the external inclination groove and the internal inclination groove, thereby preventing play in a circumferential direction during variation in length.

A telescopic shaft according to the present invention may be configured in such a way that an external inclination groove inclined in a predetermined direction and an external inclination groove inclined in an opposite direction thereto cross each other in a circumferential direction so as to enhance an effect of preventing play.

A telescopic shaft according to the present invention may include a cage including a second space portion incised in a circumferential direction and is configured in such a way one ball positioned at the intersection between the external inclination groove and the internal inclination groove is disposed in the second space portion so as to maintain the cage at a predetermined location in an axial direction, thereby preventing separation of the ball.

The foregoing exemplary embodiments and advantages are merely exemplary and are not to be construed as limiting the present invention. The present teaching can be readily applied to other types of apparatuses. Additionally, the description of the exemplary embodiments of the present invention is intended to be illustrative, and not to limit the scope of the claims, and many alternatives, modifications, and variations will be apparent to those skilled in the art.

What is claimed is:

1. A telescopic shaft comprising:
a first shaft comprising a first coupler having an inner circumferential surface comprising an external straight groove and an external inclination groove formed thereon, the external straight groove being formed in parallel to a rotation axis and the external inclination groove being inclined with respect to the external straight groove at a predetermined angle and being shaped like a spiral;
a second shaft comprising a second coupler inserted into the first coupler and having an outer circumferential surface comprising an internal straight groove and an internal inclination groove formed thereon, the internal straight groove corresponding to the external straight groove and the internal inclination groove being inclined in an opposite direction to the external inclination groove at a predetermined angle with respect to the internal straight groove and being shaped like a spiral;
a plurality of balls arranged in a line in an axial direction between the external straight groove and the internal straight groove, one ball being arranged between the external inclination groove and the internal inclination groove; and
a cage disposed between the inner circumferential surface of the first coupler and the outer circumferential surface of the second coupler, comprising a first space portion incised in an axial direction and a second space portion incised in a circumferential direction, and shaped like a tube,
wherein:
the first shaft and the second shaft are coupled to extend and retract in an axial direction; and
the plurality of balls is disposed in a line between the external straight groove and the internal straight groove are positioned in the first space portion and one ball is disposed between the external inclination groove and the internal inclination groove is positioned in the second space portion.

2. The telescopic shaft as claimed in claim 1, wherein:
an even number of the external inclination grooves are used, and any one of the external inclination grooves and another external inclination groove adjacent thereto are inclined in opposite directions; and
an even number of the internal inclination grooves corresponding to the external inclination grooves are used, and any one of the internal inclination grooves and another internal inclination groove adjacent thereto are inclined in opposite directions.

3. The telescopic shaft as claimed in claim 2, wherein:
the external straight groove and the external inclination groove of the first coupler are alternately arranged in a circumferential direction on the inner circumferential surface; and
the internal straight groove and the internal inclination groove of the second coupler are alternately arranged in a circumferential direction on the outer circumferential surface.

4. The telescopic shaft as claimed in claim 1, wherein:
a length of the first space portion in an axial direction is greater than a length of the second space portion in the axial direction; and
a width of the second space portion in a circumferential direction is greater than a width of the first space portion in the circumferential direction.

5. The telescopic shaft as claimed in claim 1, wherein:
the external inclination groove and the internal inclination groove are disposed to cross each other; and
as the first shaft and the second shaft extend and retract in an axial direction, an intersection between the external inclination groove and the internal inclination groove is moved in a circumferential direction.

6. The telescopic shaft as claimed in claim 5, wherein:
one ball disposed between the external inclination groove and the internal inclination groove is positioned at the intersection between the external inclination groove and the internal inclination groove; and
play between the first shaft and the second shaft in a circumferential direction is prevented from occurring.
